(19) United States
(12) Patent Application Publication
(10) Pub. No.: US 2008/0275677 A1
(43) Pub. Date: Nov. 6, 2008

(54) SYSTEM, METHODS, AND COMPUTER READABLE MEDIA, FOR PRODUCT DESIGN USING COUPLED COMPUTER AIDED ENGINEERING MODELS

(75) Inventor: Mark D. Landon, Idaho Falls, ID (US)

Correspondence Address: TRASK BRITT, P.O. BOX 2550, SALT LAKE CITY, UT, 84110, US

(73) Assignee: OPTIMAL SOLUTIONS SOFTWARE, LLC, Idaho Falls, ID (US)

(21) Appl. No.: 12/050,638

(22) Filed: Mar. 18, 2008

Related U.S. Application Data
(60) Provisional application No. 60/918,657, filed on Mar. 19, 2007.

(51) Int. Cl. G06F 17/50

(52) U.S. Cl. 703/2

(57) ABSTRACT

Methods, systems, and computer readable media are used for analyzing a design. A finite element analysis (FEA) model and a correlated computational flow dynamics (CFD) model are defined. A parametric volume is defined with control points forming a mesh bounding a common design object of the models. Control points on the parametric volume are adjusted to develop a design deformation of the FEA model and the CFD model. An analysis loop is performed until a convergence is achieved. The analysis loop includes simulating the CFD model to develop resultant forces and simulating the FEA model with the resultant forces applied to develop resultant displacements. The analysis loop also includes deforming the CFD model and the FEA model to match the resultant displacements by adjusting control points on the parametric volume to generate a corresponding analysis deformation of the FEA model and the CFD model.

### CROSS-REFERENCE TO RELATED APPLICATIONS

This application claims the benefit of U.S. Provisional Patent Application Ser. No. 60/918,657 filed Mar. 19, 2007 for SYSTEM AND METHOD FOR PRODUCT DESIGN USING COUPLED-PHYSICS DESIGN DEFORMATION TECHNOLOGY, the disclosure of which is incorporated by reference herein in its entirety.

### TECHNICAL FIELD

Embodiments of the present invention relate generally to methods for analyzing and designing products, and more specifically for analyzing and adjusting simulation models of product designs. BACKGROUND

Today, engineers often model designs using Computer-Aided Design (CAD) tools and simulations to develop product without having to actually build the product until the engineers have thoroughly analyzed the design. FIG. 1 illustrates a conventional product design process 10.

As part of the design process, a CAD model is created 12. When a design model is ready to analyze, a digital simulation model (also known as a Computer Aided Engineering (CAE) model) such as Finite Element Analysis (FEA) or Computational Fluid Dynamics (CFD) may be created 14. The CAE model is simulated 16 (i.e., solved) to predict certain behaviors or performance aspects of the design. The performance of the design may be assessed 20 based on the simulation of the CAE model. Decision block 22 indicates whether the design is acceptable based on the assessment of the simulation results. If the design is acceptable, the design process may terminate. If, however, the design needs more refinement, design parameters are modified 24 and the design process begins again by creating a new or modified CAD model. This process of designing, modeling, creating analysis models and assessing the analysis results may be repeated many times until the desired performance of the design is achieved.

One difficult portion of this process is the conversion of the design or CAD model into a CAE model or a “mesh.” CAD and CAE models are fundamentally based on entirely different geometric models. CAD models include precise surface representations of the boundaries of the design model. CAE models are created from polygonal building blocks, such as triangles, squares, tetrahedrons, and hexahedrons in three dimensions. Creation of a CAE model or mesh from a CAD model is often a laborious, hands-on process. As a result, currently it may often take hours or days to create an accurate CAE model. Additionally, for each design change, no matter how small, the CAE model has to be completely recreated.

Another less obvious problem with the process is that the ability to modify the CAE model is restricted by the parameters associated with the CAD model. As the engineer comes to better understand the weaknesses of his original design, he may want to change the shape of the model in a way that the original CAD model will not allow.

Free-Form Deformation (FFD) has become an important tool in computer graphics for deforming and changing the shape of objects for character animation and other visual effects in computer graphics. In FFD, the computer graphics object is embedded in a parametric space. FIG. 2 illustrates a computer graphics shape 50 in a parametric space 60. Points on the object are embedded by calculating their parametric coordinates inside that parametric space. The shape of the parametric space may then be changed, as illustrated in FIG. 2. As the parametric shape 60′ is changed, the mapping from parametric space to Cartesian space is changed so that the computer graphics object 50′ is deformed in a corresponding relationship with the parametric space. An FFD is characterized by a grid of control points that define the parametric space. Using FFD may be considered analogous to a sculptor molding clay. As the control points are pushed and pulled in different directions, the model is deformed in a manner similar to how a sculptor molds a clay model by pushing and pulling on points of the surface of the clay model.

A description of FFD is found in Sederberg, T. W. and Parry, SR., “Free-form Deformation of Solid Geometric Models,” Computer Graphics: Proceedings of SIGGRAPH 86, vol. 20, no. 4, pp. 151-159 (August 1986), which is incorporated herein by reference. A further description is found in U.S. Pat. No. 4,821,214 issued to Sederberg, T. W. on Apr. 11, 1989, which is also incorporated by reference herein.

There is a need for new ways to perform product design using CAD and CAE models in combination with FFD. Additionally, there is a need to enhance the FFD process to be applicable to multiple CAE models, reduce database requirement, and enable design modifications at a broad range of detail.

### BRIEF SUMMARY OF THE INVENTION

Embodiments of the present invention provide systems, methods, and computer readable media for performing product design and analysis. The new methods of product design use CAD and CAE models in combination with FFD by enabling coupled deformation of multiple correlated CAE models configured for analyzing different physical parameters. Additionally, the FFD process may use T-spline meshes to reduce database requirement, increase design flexibility and enable design modifications at a broad range of detail.

An embodiment of the invention includes a method for analyzing a design. The method includes defining a finite element analysis (FEA) model and defining a computational flow dynamics (CFD) model correlated with the FEA model. The method also includes forming a parametric volume comprising a plurality of control points forming a mesh at least partially bounding a common design object of the FEA model and the CFD model. At least one control point on the parametric volume is adjusted to develop a design deformation of at least a portion of the FEA model correlated to the at least one control point and a design deformation of at least a portion of the CFD model correlated to the at least one control point. The method also includes iteratively solving the CFD model and the FEA model to determine a fluid-structure-interaction result.

Another embodiment of the invention also includes a method for analyzing a design. The method includes defining associated models comprising a finite element analysis (FEA) model of the design and a computational flow dynamics (CFD) model of the design. A parametric volume comprising a plurality of control points forming a mesh at least partially bounding a design object of the FEA model and the CFD model is defined. The method includes performing an analysis loop until a substantial convergence is achieved. The analysis loop includes simulating the CFD model to develop resultant forces and simulating the FEA model with the resultant forces applied to develop resultant displacements. The analysis loop also includes deforming the CFD model and the FEA model to substantially match the resultant displacements by adjusting at least one control point on the parametric volume to generate a corresponding analysis deformation of the FEA model and the CFD model. The analysis loop also includes repeating simulating the CFD model, simulating the FEA model, and deforming the CFD model and the FEA model, until the CFD model, the FEA model, or combination thereof has substantially converged.

Another embodiment of the invention includes a computing system. The computing system includes a display, memory, and at least one processor coupled to the display and memory. The computing system is configured for defining a finite element analysis (FEA) model and defining a computational flow dynamics (CFD) model correlated with the FEA model. The method also includes forming a parametric volume comprising a plurality of control points forming a mesh at least partially bounding a common design object of the FEA model and the CFD model. At least one control point on the parametric volume is adjusted to develop a design deformation of at least a portion of the FEA model correlated to the at least one control point and a design deformation of at least a portion of the CFD model correlated to the at least one control point. The method also includes iteratively solving the CFD model and the FEA model to determine a fluid-structure-interaction result.

Yet another embodiment of the invention includes a computer readable media including computer executable instructions to be executed on a processor. When executing the computer instruction, the processor performs acts for defining associated models comprising a finite element analysis (FEA) model of the design and a computational flow dynamics (CFD) model of the design. The processor also performs acts for defining a parametric volume comprising a plurality of control points forming a mesh at least partially bounding a design object of the FEA model and the CFD model. The processor also performs acts for performing an analysis loop until a substantial convergence is achieved. The analysis loop includes simulating the CFD model to develop resultant forces and simulating the FEA model with the resultant forces applied to develop resultant displacements. The analysis loop also includes deforming the CFD model and the FEA model to substantially match the resultant displacements by adjusting at least one control point on the parametric volume to generate a corresponding analysis deformation of the FEA model and the CFD model. The analysis loop also includes repeating simulating the CFD model, simulating the FEA model, and deforming the CFD model and the FEA model, until the CFD model, the FEA model, or combination thereof has substantially converged.

### BRIEF DESCRIPTION OF THE SEVERAL VIEWS OF THE DRAWINGS

In the drawings, which illustrate embodiments of the invention:

FIG. 1 is a flow chart illustrating a conventional product design methodology;

FIG. 2 illustrates a FFD distortion of a computer graphics shape;

FIG. 3 illustrates a Non-Uniform Rational B-Spline (NURBS) curve;

FIG. 4 illustrates a control mesh for a NURBS surface in two-dimensions;

FIG. 5 illustrates a T-spline control mesh for a surface in two-dimensions;

FIG. 6 illustrates a T-spline control mesh for a three-dimensional volume;

FIG. 7 is a Graphical User Interface (GUI) window illustrating a CAE model and a T-spline control mesh;

FIG. 8 is a GUI window illustrating a CAE model and T-spline control mesh with a control point deforming a control surface;

FIG. 9 illustrates two GUI windows illustrating a Computational Flow Dynamics model, a finite element analysis (FEA) model, and a T-spline control mesh;

FIG. 10 illustrates two GUI windows illustrating a Computational Flow Dynamics model and a finite element analysis (FEA) model after a design deformation;

FIG. 11 is a simplified flow chart illustrating a product design process according to one or more embodiments of the present invention;

FIG. 12 is a simplified flow chart illustrating a coupled CAE analysis process according to one or more embodiments of the present invention;

FIG. 13 is a graph illustrating convergence of CAE models resulting from the analysis process in FIG. 12; and

FIG. 14 is a simplified block diagram of a computing system useful for performing embodiments of the present invention.

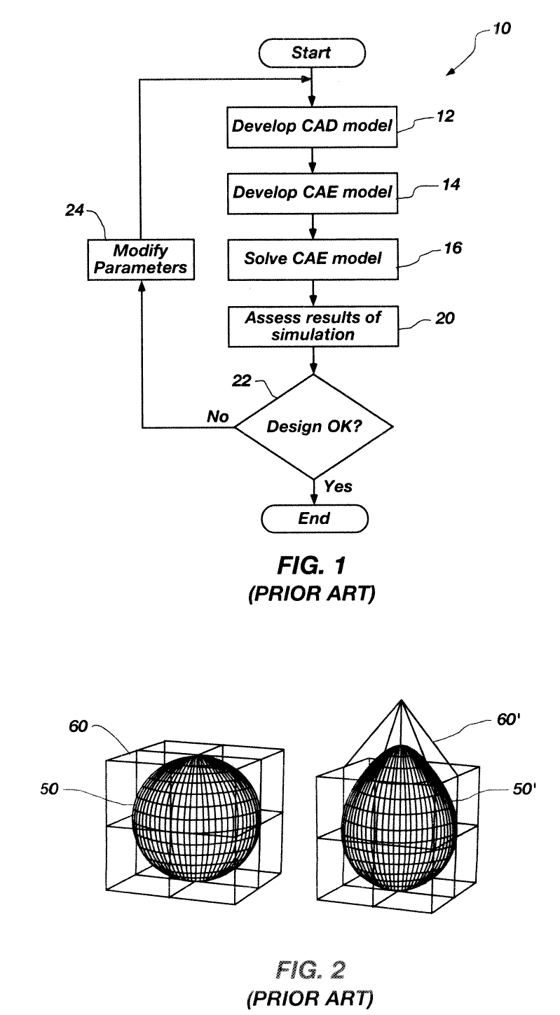

### DETAILED DESCRIPTION OF THE INVENTION

In the following detailed description, reference is made to the accompanying drawings which form a part hereof, and in which is shown by way of illustration specific embodiments in which the invention may be practiced. These embodiments are described in sufficient detail to enable those of ordinary skill in the art to practice the invention. It should be understood, however, that the detailed description and the specific examples, while indicating examples of embodiments of the invention, are given by way of illustration only and not by way of limitation. From this disclosure, various substitutions, modifications, additions rearrangements, or combinations thereof within the scope of the present invention may be made and will become apparent to those skilled in the art.

Software processes and analysis methods illustrated herein are intended to illustrate representative processes that may be performed by a general purpose or special purpose processing system. Unless specified otherwise, the order in which the process acts are described is not intended to be construed as a limitation, and acts described as occurring sequentially may occur in a different sequence, or in one or more parallel process streams. It will be appreciated by those of ordinary skill in the art that many steps and processes may occur in addition to those outlined in the flow charts. Furthermore, the processes may be implemented in any suitable hardware, software, firmware, or combinations thereof.

When executed as firmware or software, the instructions for performing the processes may be stored on a computer-readable medium. A computer-readable medium includes, but is not limited to, magnetic and optical storage devices such as disk drives, magnetic tape, CDs (compact disks), DVDs (digital versatile discs or digital video discs), and semiconductor devices such as RAM, DRAM, ROM, EPROM, and Flash memory.

By way of non-limiting example, computing instructions for performing the processes may be performed on a processing system (not shown). In the processing system, the computing instructions may be stored on operational storage, transferred to a memory for execution, and executed by one or more processors. The one or more processors, when executing computing instructions configured for performing the processes, constitutes structure for performing the processes. In addition, some or all portions of the processes may be performed by hardware specifically configured for carrying out the processes.

Embodiments of the present invention provide systems, methods, and computer readable media for performing product design and analysis. The new methods of product design use CAD and CAE models in combination with FFD by enabling coupled deformation of multiple correlated CAE models configured for analyzing different physical parameters. Additionally, the FFD process may use T-spline meshes to reduce database requirement, increase design flexibility and enable design modifications at a broad range of detail.

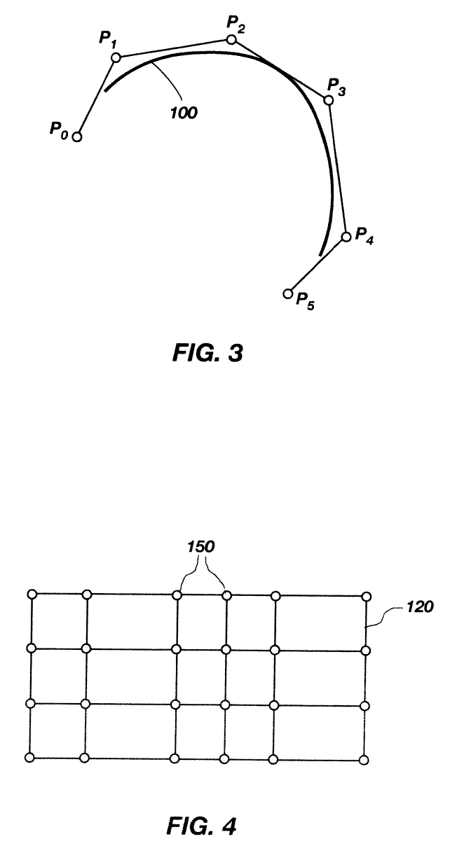

FIG. 3 illustrates a free-form Non-Uniform Rational B-Spline (NURBS) curve 100. A NURBS curve 100 is a parametric curve, meaning that the points along the curve smoothly change as the parameters of the curve change. The NURBS curve 100 can be described and visually represented by control point (P0-P5) around the NURBS curve 100. The NURBS curve 100 is formed by interpolating the position of the curve's control points as the parameters change. Additional control points can be added to create finer detail and sharper curves. NURBS curves 100 are particularly useful to designers because they provide continuity of the curve and local control that only affects the curve near the control point and its neighbors. In general, NURBS curves 100 may have multiple degrees. A cubic NURBS curve 100 can be decomposed into multiple adjacent cubic Bezier curves. The parameter values at which two adjacent Bezier curves meet are called knot values (or simply knots). Thus, a NURBS curve 100 is described by a series of control points and a sequence of knot values. A NURBS curve 100 exhibits local control. In other words, a control point strongly influences the closest Bezier curve, weakly influence neighboring Bezier curves and has little or no influence on more distant Bezier curves.

FIG. 4 illustrates a control mesh 120 for a NURBS surface in two-dimensions. A NURBS surface 120 is similar to a NURBS curve but in two dimensions. The control points 150, and knot values, define a resultant NURBS surface (not shown). The knot values are defined for two-dimensional space. As with a NURBS curve, a bi-cubic NURBS surface exhibits local control such that a given control point 150 strongly influences the NURBS surface closest to the control point and more weekly influences the NURBS surface moving away from the control point.

A control mesh 120 forms a rectangular grid with control points 150 at the intersections of the grids. Thus, to add a new control point, a new line must be added in each direction, along with control points at each intersection of the new line. As a result, many of the control points are of limited use, or serve no purpose except to satisfy the rectangular grid topology.

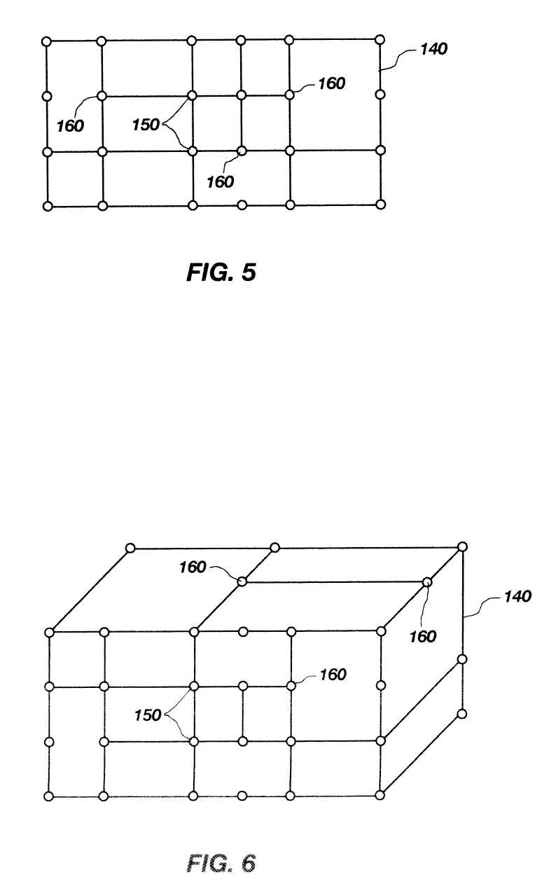

FIG. 5 illustrates a T-spline control mesh 140 (also referred to as a T-mesh) for a surface in two-dimensions. One difference between a T-mesh 140 and a NURBS control mesh 120 (FIG. 4) is that a T-mesh 140 allows a row of control points to terminate. Thus, a row may include many points or a single point. As a result, in a T-mesh 140 the control points may include cross-points 150 and T-points 160. With a T-mesh 140, conventional NURBS control points (i.e., cross-points 150) that may not be useful in defining or deforming the underlying surface may be removed to simplify the T-mesh 140. Conversely, new control points can be added as T-points 160 without having to add corresponding cross-points 150 at every intersection along a given line.

FIG. 6 illustrates a T-spline control mesh for a three-dimensional volume. As with the two-dimensional surface, a volume T-mesh 140 may include both cross-points 150 and T-points 160 as control points for the three-dimensional T-spline control mesh 140. In embodiments of the present invention, T-spline control meshes 140 may be applied to an underlying geometric shape or CAE model of the geometric shape to carry out Free-Form Deformation (FFD) of the underlying CAE model.

Conventional FFD has several shortcomings. One problem is that frequently, certain elements of the design may not be changed while other features of the design are being modified. In order to isolate parts of the design from the deformation, control points must be inserted into the CAE model. Since the control points of a conventional FFD are required to be topologically arranged in a lattice, the addition of control points causes entire planes of control points to be inserted. This produces a significant proliferation of control points. These control points are, therefore, frequently added in locations where they are not desired and serve no purpose other than to satisfy topological requirements.

Embodiments of the present invention overcome many problems of conventional product design by enabling FFD of a CAE model, rather than the CAD model. The FFD may be performed using T-spline control meshes 140 to create a smaller database of control points that are easier to manipulate and enhance for fine control of the CAE model. In addition, the FFD is performed on more than one CAE model of the same underlying CAD model.

With deformation of the CAE model, CAD model modification and re-creation of the simulation model are removed from the design improvement cycle. If the accuracy of the CAE model is maintained, the product design cycle using simulation models can proceed quickly and can easily be automated.

In addition, T-Splines overcome many of the shortcomings of conventional FFD. T-Splines are not constrained by “superfluous” control points lying in a rectangular grid. T-Splines are also locally refineable. Therefore, the control points can be inserted into the control grid without propagating an entire plane of control points. Thus, the CAE model may be embedded in a parametric volume formed as a T-spline control mesh 140. Points on the CAE model are embedded by calculating their parametric coordinates inside that parametric space. The shape of the parametric space may then be changed by moving and modifying control points. As the parametric shape is changed, the mapping from parametric space to Cartesian space is changed so that the CAE model is deformed in a corresponding relationship with the parametric space. In other words, as the shape of the T-Spline volume is changed, the embedded CAE model is deformed in an analogous manner. For a cubic T-Spline, C¹ continuity is ensured so that the accuracy of the deformed elements of the CAE model is maintained.

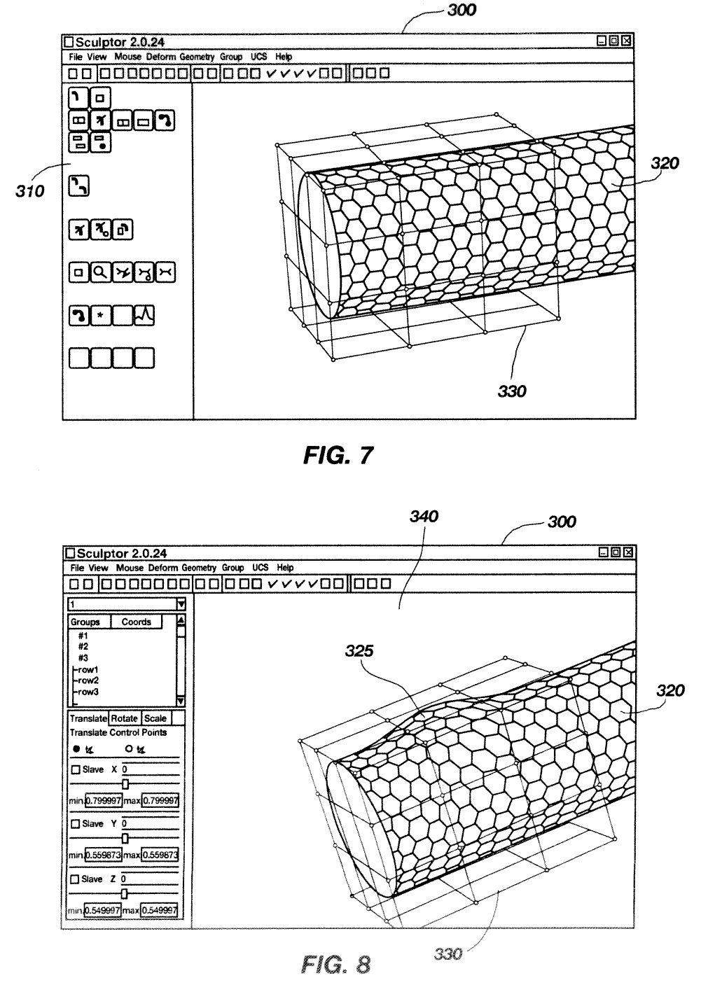

FIG. 7 is a Graphical User Interface (GUI) window 300 illustrating a CAE model 320 and a T-spline control mesh 330. As a non-limiting example, the CAE model 320 may be configured as a mesh of hexagons or other polyhedrons suitable for, as a non-limiting example, performing computational fluid dynamics analysis in and around the CAE model 320.

A variety of tools 310 are shown in the GUI for controlling operations, such as, for example, rotating and translating views, building and modifying the T-mesh, deforming the T-mesh, controlling simulations, and performing optimizations.

FIG. 8 is a GUI window 300 illustrating the CAE model 320 and T-spline control mesh 330 with a moved control point 340. The moved control point causes a deformation 325 of portions of the underlying CAE model 320. As can be seen in FIG. 8, movement of a single control point may result in movement of a large number of points on the underlying CAE model 320.

After the control mesh is created, it may be modified to tightly encapsulate the underlying grid. The closer a control mesh conforms to the grid surface of the CAE model, the more responsive the grid is to the movements of the control points. In addition, non-useful control points may be eliminated and additional control points may be added to enable more precise control of deformations.

In addition to adding and removing control points as either T-points or cross-points, points may be lumped together in groups to provide higher order control over the control points. When a group is manipulated, all the points in the group are affected according to a relationship that may defined by tools in the GUI window. As a non-limiting example, when a T-mesh volume is created, the points in each coordinate plane may be automatically lumped into individual groups. This plane grouping enables all the plane's points to move together simply by moving the plane.

Many design and analysis processes need to consider fluid structure interaction (FSI). Generally, a fluid flow around a design element produces pressures, temperatures, or combinations thereof, which may deform the surrounding structure. In turn, these structural deformations may change the fluid flow. The ability for software to recreate the interaction of a flexible structure immersed in a flowing fluid field is an important component of the design stage for many fields of engineering. As non-limiting examples, FSI may be important in determining the stability and response of an aircraft wing, the response of a high-pressure sensor introduced into a pipe flow, or a down-force-generating wing on a racecar.

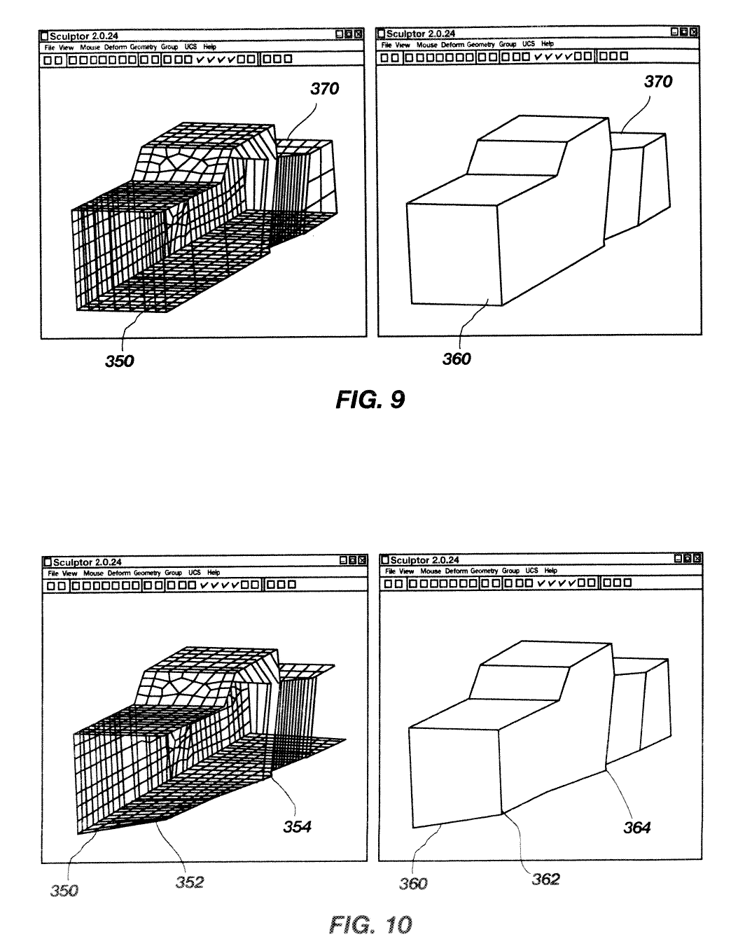

FIG. 9 illustrates two GUI windows illustrating a Computational Flow Dynamics (CFD) model 360 and finite element analysis (FEA) model 350. The models represent a fuel injection strut in a scramjet combustor. Both GUI windows also illustrate a T-spline control mesh 370 that is common to the two CAE models (350 and 360). As can be seen from the CAE model (350 and 360), different levels of detail may be required at different locations for structural analysis relative to fluid analysis. However, since both models represent the same underlying geometry, a single parametric volume 370 (i.e., T-spline control mesh 370) may be used for performing arbitrary shape deformation. With the same T-spline control mesh 370, moving a control point on the mesh will result in substantially the same deformation to both the underlying FEA model 350 and the underlying CFD model 360.

FIG. 10 illustrates two GUI windows illustrating the CFD model 360 and the FEA model 350. In FIG. 10, the T-spline control mesh 370 is not shown. However, FIG. 10 does illustrate a deformation of the FEA model 350 and the CAE model (350 and 360) as a result of moving control points on the t-spline control mesh 370. Thus, points 352 and 362 illustrate that the front face of the fuel injection strut has been modified by moving the right side of the strut back relative to the left side. Points 354 and 364 illustrate that a point on the bottom of the strut, about midway back, has been moved to the right, thus modifying portions of the models near points 354 and 364.

In embodiments of the present invention, two different types of deformation to the CAE models (350 and 360) may be present. One type of deformation is a “design deformation,” which occurs by the user moving control points to modify the underlying CAE models (350 and 360) in an experiment to meet certain design objectives. Another type of deformation is an “analysis deformation,” which occurs when the CFD model 360 and FEA model 350 are applied against each other in an analysis loop. Details of the analysis loop and analysis deformation are explained more fully below.

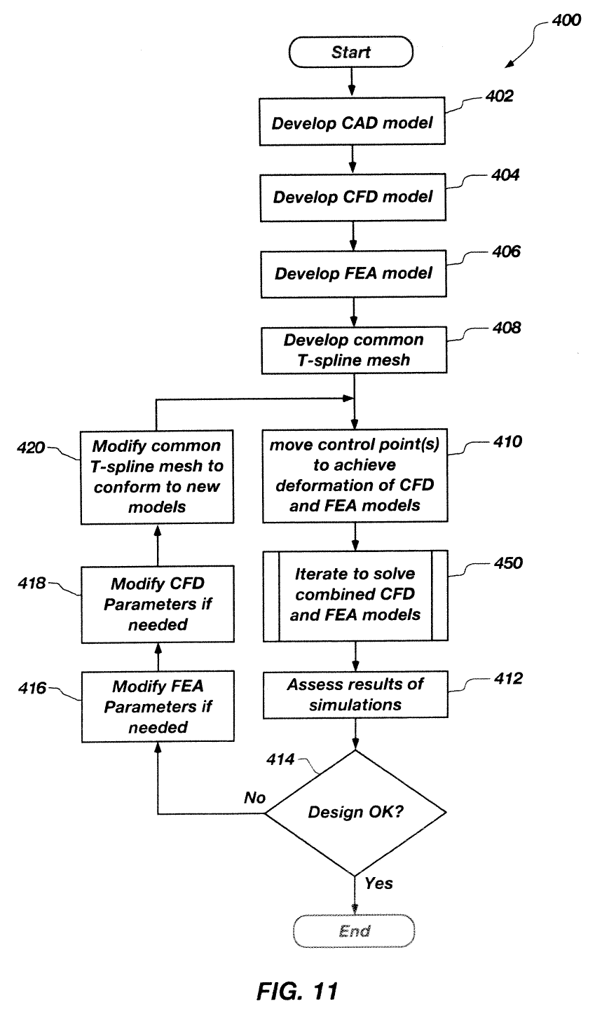

FIG. 11 is a simplified flow chart illustrating a product design process 400 according to one or more embodiments of the present invention. A CAD model is created in operation block 202. Of course, other kinds of models may be used in embodiments of the present invention. By way of non-limiting example, a model also may be developed from scanning an object with a laser, Computerized Axial Tomography (CAT) scans (sometimes called CT scans), or electromagnetic response maps.

A CFD model is derived from the CAD model in operation block 404 and a FEA model is derived from the CAD model in operation block 406.

In operation block 408, a T-spline control mesh is formed around all or portions of the CAE models. The T-spline control mesh will be common to the CFD model and the FEA model such that movement of control points on the T-spline control mesh perform an arbitrary shape deformation of both underlying CAE models in substantially the same manner.

In operation block 410, one or more control points on the T-mesh are moved to create a design deformation of the underlying CAE models in a manner that may produce behavior of the model targeted to meet various design objectives. For example, in the fuel injection strut illustrated in FIGS. 9 and 10, the design objective may be to increase laminar fluid flow while holding analytical deformation of the strut within certain tolerances.

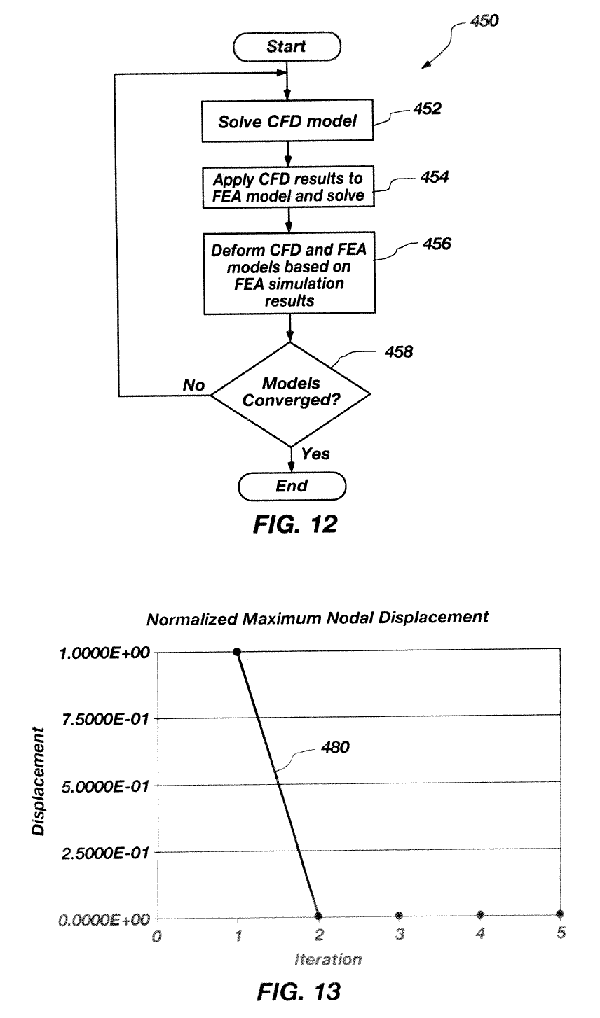

Operation block 450 performs analysis iterations to solve the combined CFD and FEA models, as is explained below with reference to FIG. 12. The result is a fluid-structure-interaction result.

In operation, block 412 the fluid-structure-interaction result is assessed to determine if the design objectives have been achieved. Decision block 414 indicates a decision of whether the design meets the design objectives. If the design is acceptable, the design process may terminate. If, however, the design needs more refinement, operation block 416 optionally may modify design parameters of the CFD model such as boundary conditions, fluid properties, and other appropriate parameters affecting the CFD analysis. In addition, operation block 418 optionally may modify design parameters of the FEA model such as external forces, material properties, and other appropriate parameters affecting the FEA analysis.

Operation block 420 optionally may modify parameters of the T-mesh. The T-mesh may be modified by removing control points or adding control points to refine how the CAE model will deform with movement of control points. The T-mesh may also be modified to encompass additional portions of the underlying CAE model. With potential changes to the CAE models and the T-mesh, the design loop begins again at operation block 410 with new T-mesh deformations, CAE model analysis 450, and assessment of the simulation results 412. The design loop may continue until the design objectives have been met.

FIG. 12 is a simplified flow chart illustrating a coupled CAE analysis process 450 according to one or more embodiments of the present invention. The coupled CAE analysis 450 is performed as part of the design process 400 discussed above with reference to FIG. 11. The CAE analysis 450 begins at operation block 452 with a CFD mesh being read into the CFD analyzer along with appropriate boundary conditions. The CFD analyzer solves the flow field and generates various pressure and temperature results. In operation block 454, the pressures and temperatures are applied to a FEA mesh in a structural FEA analyzer. A structural analysis is performed, producing nodal displacements (i.e., the analysis deformations).

In operation block 456 arbitrary shape deformation is performed by moving control points on the t-mesh to substantially match the structurally deformed geometry from the FEA model after the simulation. By modifying the t-mesh, a corresponding deformation can also be applied to the CFD model.

Decision block 458 tests to see if the models have converged. As a non-limiting example, convergence may be measured in a number of ways. For example, by measuring that flow patterns in this loop iteration are almost the same (e.g., within an acceptable tolerance) as flow patterns from the previous iteration. Another non-limiting example of convergence may be when node displacements in the FEA model are almost the same (e.g., within an acceptable tolerance) as node displacements from the previous iteration. If the models have converged, the coupled CAE analysis process 450 ends. If the models have not converged, the iteration loop returns to operation block 452 to begin a new analysis iteration.

Those of ordinary skill in the art will recognize that many different CFD analyzers and FEA analyzers are commercially available and may be used in embodiments of the present invention.

FIG. 13 is a graph illustrating convergence of CAE models resulting from the analysis process in FIG. 12. In FIG. 13 normalized maximum nodal displacement was used as a convergence criterion. As can be seen from line 480, in this case convergence was achieved after a single iteration. Additional iterations were performed to verify that the analysis had converged.

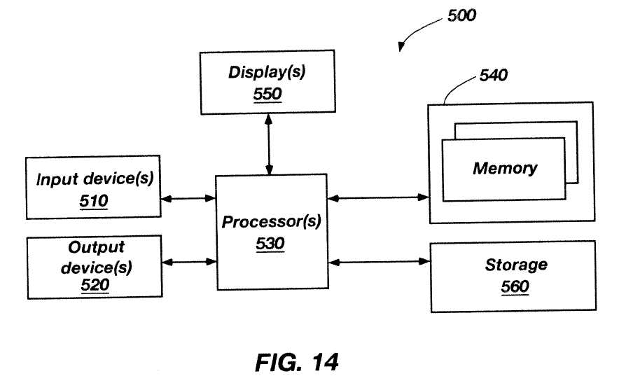

FIG. 14 is a simplified system block diagram of a computing system useful for performing embodiments of the present invention. As shown in FIG. 13, a computing system 500 may include at least one input device 510, at least one output device 520, at least one processor 530, memory 540, a display 550, and at least one storage device 560.

The memory 540 and storage devices 560 are configured for holding information including firmware or software including instructions for execution by the processor 530. The display may be used to display a GUI including depictions of CAD models, CAE models, T-meshes, and tools for manipulating and simulating the models and meshes.

The input devices and output devices may include a keyboard, a mouse, a joystick, a haptic device, communication devices, and other suitable devices for controlling operation of the computing system.

Although the present invention has been described with reference to particular embodiments, the present invention is not limited to these described embodiments. Rather, the present invention is limited only by the appended claims, which include within their scope all equivalent devices or methods that operate according to the principles of the present invention as described.

What is claimed is:

1. A method for analyzing a design, comprising:
defining a finite element analysis (FEA) model;
defining a computational flow dynamics (CFD) model correlated with the FEA model;
forming a parametric volume comprising a plurality of control points forming a mesh at least partially bounding a common design object of the FEA model and the CFD model;
adjusting at least one control point on the parametric volume to develop a design deformation of at least a portion of the FEA model correlated to the at least one control point and a design deformation of at least a portion of the CFD model correlated to the at least one control point; and
iteratively solving the CFD model and the FEA model to determine a fluid-structure-interaction result.

2. The method of claim 1, wherein the iteratively solving comprises:
simulating the CFD model to develop resultant forces;
simulating the FEA model with the resultant forces applied to develop resultant displacements;
producing an analysis deformation of at least a portion of the CFD model and the FEA model to substantially match the resultant displacements; and repeating simulating the CFD model, simulating the FEA model, and producing the analysis
deformation until the CFD model, the FEA model, or combination thereof has substantially converged.

3. The method of claim 2, wherein simulating the CFD model also develops resultant temperatures and simulating the FEA model includes applying the resultant temperatures.

4. The method of claim 1, further comprising:
analyzing the fluid-structure-interaction result relative to at least one design objective; and
repeating the adjusting and the iteratively solving until the at least one design objective has been achieved.

5. The method of claim 4, wherein the process of analyzing the fluid-structure-interaction result and repeating the adjusting and the iteratively solving is automated by a process of automatically iterating through a range of control point adjustments.

6. The method of claim 1, wherein the parametric volume includes at least one T-spline control point.

7. The method of claim 1, further comprising refining the parametric volume by adding additional control points to the parametric volume wherein the additional control points are selected from the group consisting of T-points and cross-points.

8. The method of claim 1, further comprising refining the parametric volume by removing control points from the parametric volume wherein the removed control points are selected from the group consisting of T-points and cross-points.

9. The method of claim 1, further comprising refining the parametric volume by grouping two or more control points to move together.

10. The method of claim 1, wherein defining the FEA model and defining the CFD model further comprises deriving the FEA model and deriving the CFD model from a Computer-Aided Design (CAD) model.

11. A method for analyzing a design, comprising:
defining associated models comprising a finite element analysis (FEA) model of the design and a computational flow dynamics (CFD) model of the design;
defining a parametric volume comprising a plurality of control points forming a mesh at least partially bounding a design object of the FEA model and the CFD model; and
performing an analysis loop until a substantial convergence is achieved, the analysis loop comprising:
simulating the CFD model to develop resultant forces;
simulating the FEA model with the resultant forces applied to develop resultant displacements;
deforming the CFD model and the FEA model to substantially match the resultant displacements by adjusting at least one control point on the parametric volume to generate a corresponding analysis deformation of the FEA model and the CFD model; and
repeating simulating the CFD model, simulating the FEA model, and deforming the CFD model and the FEA model, until the CFD model, the FEA model, or combination thereof has substantially converged.

12. The method of claim 11, wherein simulating the CFD model also develops resultant temperatures and simulating the FEA model includes applying the resultant temperatures.

13. The method of claim 11, further comprising repeatedly performing a design loop until a design objective is achieved, the design loop comprising:
producing a design deformation of at least a portion of the CFD model and the FEA model by adjusting at least one control point on the parametric volume to deform at least a portion of the FEA model and the CFD model based on the design objective; and
performing the analysis loop.

14. The method of claim 11, wherein the parametric volume includes at least one T-spline control point.

15. The method of claim 11, wherein defining the FEA model and defining the CFD model further comprises deriving the FEA model and the CFD model from a Computer-Aided Design (CAD) model.

16. A computing system, comprising:
a display;
a memory; and
at least one processor operably coupled to the display and the memory;
wherein the computing system is configured for:
defining a finite element analysis (FEA) model;
defining a computational flow dynamics (CFD) model correlated with the FEA model;
forming a parametric volume comprising a plurality of control points forming a mesh at least partially bounding a common design object of the FEA model and the CFD model;
adjusting at least one control point on the parametric volume to develop a design deformation of at least a portion of the FEA model correlated to the at least one control point and a design deformation of at least a portion of the CFD model correlated to the at least one control point; and
iteratively solving the CFD model and the FEA model to determine a fluid-structure-interaction result.

17. The computing system of claim 16, wherein the iteratively solving comprises:
simulating the CFD model to develop resultant forces;
simulating the FEA model with the resultant forces applied to develop resultant displacements;
producing an analysis deformation of at least a portion of the CFD model and the FEA model to substantially match the resultant displacements; and
repeating simulating the CFD model, simulating the FEA model, and producing the analysis deformation until the CFD model, the FEA model, or combination thereof has substantially converged.

18. The computing system of claim 17, wherein simulating the CFD model also develops resultant temperatures and simulating the FEA model includes applying the resultant temperatures.

19. The computing system of claim 16, wherein the computing system is further configured for:
analyzing the fluid-structure-interaction result relative to at least one design objective; and
repeating the adjusting and the iteratively solving until the at least one design objective has been achieved.

20. A computer readable media including computer executable instructions, which when executed on a processor perform acts, comprising:
defining associated models comprising a finite element analysis (FEA) model of the design and a computational flow dynamics (CFD) model of the design;
defining a parametric volume comprising a plurality of control points forming a mesh at least partially bounding a design object of the FEA model and the CFD model; and
performing an analysis loop until a substantial convergence is achieved, the analysis loop comprising:
simulating the CFD model to develop resultant forces;
simulating the FEA model with the resultant forces applied to develop resultant displacements;
deforming the CFD model and the FEA model to substantially match the resultant displacements by adjusting at least one control point on the parametric volume to generate a corresponding analysis deformation of the FEA model and the CFD model; and
repeating simulating the CFD model, simulating the FEA model, and deforming the CFD model and the FEA model, until the CFD model, the FEA model, or combination thereof has substantially converged.

21. The computer readable media of claim 20, wherein simulating the CFD model also develops resultant temperatures and simulating the FEA model includes applying the resultant temperatures.

22. The computer readable media of claim 20, further comprising computer executable instructions, which when executed on a processor repeatedly perform a design loop until a design objective is achieved, the design loop comprising:
producing a design deformation of at least a portion of the CFD model and the FEA model by adjusting at least one control point on the parametric volume to deform at least a portion of the FEA model and the CFD model based on the design objective; and
performing the analysis loop.

23. The computer readable media of claim 20, further comprising computer executable instructions for refining the parametric volume by adding additional control points to the parametric volume or removing control points from the parametric volume, wherein the control points are selected from the group consisting of T-points and cross-points.
